(19) United States
(12) Patent Application Publication
(10) Pub. No.: US 2026/0349140 A1
(43) Pub. Date: Nov. 5, 2026

(54) SLOPE STABILITY MONITORING AND EVALUATION METHOD BASED ON DAS OPTICAL FIBER-DISPLACEMENT SYNERGY

(71) Applicant: Guangxi University, Nanning (CN)

(72) Inventors: Jingnan ZHAO, Nanning (CN); Maofeng QIN, Nanning (CN); Shuanghong JIANG, Nanning (CN); Zilong WANG, Nanning (CN); Mingli LU, Nanning (CN); Yulin ZHOU, Nanning (CN)

(21) Appl. No.: 19/728,125

(22) Filed: Jul. 1, 2026

(30) Foreign Application Priority Data
Dec. 29, 2025 (CN) 202512000699.2

(51) Int. Cl. G01V 8/16; G01B 11/16; G01H 9/00; G01N 17/00

(52) U.S. Cl. CPC G01V 8/16; G01B 11/16; G01H 9/004; G01N 17/00

(57) ABSTRACT

The present disclosure discloses a slope stability monitoring and evaluation method based on DAS optical fiber-displacement coordination, involving the field of slope engineering, including the following steps: constructing a distributed optical fiber deformation monitoring system, constructing a displacement monitoring system, collecting data through the displacement monitoring system and the distributed optical fiber deformation monitoring system, processing the data through the matlab data analysis software, establishing the mathematical relationship between the vibration signal and the displacement data, and predicting the displacement value of the slope surface based on the mathematical relationship; using single-mode optical fiber as a continuous sensing network, it overcomes the disadvantages of limited monitoring range and high maintenance cost of traditional point sensors.

### TECHNICAL FIELD

The present disclosure relates to the field of slope engineering, in particular to a slope stability monitoring and evaluation method based on DAS optical fiber-displacement synergy.

### BACKGROUND

With rapid economic development and the continuous advancement of infrastructure construction, slope stability issues have become increasingly prominent, slope deformation monitoring has thus become a critical matter for ensuring engineering safety.

In existing technologies, slope stability monitoring and evaluation are conducted using point sensors, InSAR, or photogrammetry. First, traditional methods can only obtain information from a limited number of monitoring points, making it difficult to achieve comprehensive monitoring of large-scale progressive slope deformation or potential sliding surfaces; as a result, local information cannot represent the overall stability of the slope. Second, traditional methods typically require a post-data processing cycle, which makes real-time monitoring and dynamic early warning of key deformation stages before a disaster difficult to achieve, thereby limiting rapid response capability under sudden inducing conditions such as heavy rainfall and earthquakes. In addition, traditional methods are affected by environmental factors such as changes in the water content of rock and soil, which may lead to decreased monitoring accuracy, and the accurate capture of deep deformation, micro-creep, or critical slip stages is particularly unsatisfactory. Finally, densely deployed point sensor networks require a large number of sensors and supporting equipment, leading to high installation and maintenance costs; they are also vulnerable to damage or failure in harsh outdoor environments, making it difficult to guarantee long-term, continuous monitoring.

Therefore, a slope stability monitoring and evaluation method based on DAS optical fiber-displacement synergy is provided to solve the above problems.

### SUMMARY

The purpose of the present disclosure is to provide a slope stability monitoring and evaluation method based on DAS optical fiber-displacement synergy, to realize real-time, dynamic, large-scale, long-distance, and high-precision monitoring of slope surface deformation, and to overcome the shortcomings of existing technologies.

In order to achieve the above purposes, the present disclosure provides a slope stability monitoring and evaluation method based on DAS optical fiber-displacement synergy, including the following steps:
S1: constructing a distributed optical fiber deformation monitoring system;
S2: constructing a displacement monitoring system;
S3: performing a data acquisition through the displacement monitoring system and the distributed optical fiber deformation monitoring system;
S4: processing data through a matlab data analysis software;
S5: establishing a mathematical relationship between a vibration signal and a displacement data;
S6: based on a mathematical relationship, predicting a displacement value of a slope surface.

In some embodiments, S1 includes the following steps:
S11: constructing a physical model of the slope, the physical model of the slope includes a model box and expansive soil set inside a model box; the box wall of the model box adopts tempered glass, and an edge of the model box adopts square steel;
S12: layering along different elevation levels, marking a laying route of single-mode optical fiber on a slope surface of expansive soil, and engraving an optical fiber groove according to the laying route;
S13: laying a single-mode fiber in the fiber groove, and backfilling and compacting the fiber groove after the laying is completed.

In some embodiments, S2 includes the following steps:
S21: setting a full-bridge cable-stayed displacement sensor on a slope surface of expansive soil, and setting the full-bridge cable-stayed displacement sensor on a middle and lower part of the slope surface;
S22: setting a temperature and humidity sensor and a dial gauge on the slope surface of expansive soil;
S23: setting a spray device on a top of the model box.

In some embodiments, S3 specifically includes the following steps:
S31: simulating a rainfall process by the spray device, simulating a rainfall intensity by a spray intensity, and obtaining a temperature and a humidity of the expansive soil by the temperature and humidity sensor during a simulated rainfall process;
S32: simulating a slope slip in the rainfall process, generating a vibration signal, and transmitting the vibration signal to the single-mode fiber through the expansive soil;
S33: connecting the single-mode fiber to the DAS interrogator, and connecting the vibration signal in real time through the DAS interrogator, and adjusting an acquisition frequency according to the spray intensity and characteristics of expansive soil;
S34: connecting the full bridge cable displacement sensor with a dynamic displacement meter, and collecting displacement data of the slope in real time by the dynamic displacement meter to record a displacement change of the slope.

In some embodiments, S4 specifically includes the following steps:
S41: denoising the vibration signal by matlab data analysis software to remove environmental interference and measurement noise;
S42: performing a Fourier transform on the denoised vibration signal to convert the vibration signal from a time domain to a frequency domain, and extracting frequency domain characteristics of the vibration signal;
S43: analyzing the displacement data using matlab data analysis software, and eliminating singular values and abnormal points.

In some embodiments, S5 specifically includes the following steps:
S51: performing a trend analysis of the frequency domain characteristics of the vibration signal, and extracting characteristic variables related to a deformation of the slope surface; a characteristic variable extraction method is set as follows:

$${F}_{feature} ( x , t ) = \frac{{\int }_{{f}_{1}}^{{f}_{2}} S ( f , x , t ) \cdot W ( f ) df}{{\int }_{{f}_{min}}^{{f}_{max}} S ( f , x , t ) df}$$

where F_{feature}(x,t) denotes an extracted frequency domain characteristic variable, S(f,x,t) denotes a frequency domain amplitude of the vibration signal at frequency f, position x and time t, [f₁, f₂] denotes a characteristic frequency interval related to the slope surface deformation, W(f) denotes a frequency weight function, and [fₘᵢₙ, fₘₐₓ] denotes an effective frequency range;
S52: according to a change trend of displacement data, determining displacement variation characteristics of the slope under rainfall.
S53: based on change trends of the vibration signal and the displacement data, establishing a mathematical relationship between the vibration signal and the displacement data; the mathematical relationship between the vibration signal and the displacement data is set as follows:

$$D ( x , t ) = {\int }_{{f}_{min}}^{{f}_{max}} [ α ( f ) \cdot S ( f , x , t ) ] df + β \cdot \frac{\partial S}{\partial x} + γ ;$$

where D(x,t) denotes a displacement of the slope surface at frequency f, position x and time t, α(f) denotes a frequency response function, β denotes a spatial gradient coefficient, and γ denotes a system error or background noise compensation term.

In some embodiments, S6 specifically includes the following steps:
S61: based on the mathematical relationship between the vibration signal and the displacement data and the frequency domain characteristics of the vibration signal, quantifying the displacement of the slope surface;
S62: based on quantitative processing results, predicting a displacement value of the slope surface, and obtaining a displacement prediction value \hat{D}(x,t) of the slope surface, the displacement prediction value \hat{D}(x,t) of the slope surface is set as:

\hat{D}(x,t)=K·ln(1+F_{feature}(x,t))+D₀;
where K denotes the model gain coefficient, D₀ denotes an initial displacement reference;
S63: showing a prediction result through visualization tools or data reports.

Therefore, the present disclosure adopts the above-mentioned slope stability monitoring and evaluation method based on DAS optical fiber-displacement synergy, which has the following beneficial effects:

(1) This scheme enables continuous monitoring along the optical fiber by means of distributed optical fiber technology. It is no longer limited to a single monitoring point, but can obtain strain and displacement data from the entire monitoring area, thereby allowing a more accurate evaluation of slope surface deformation.

(2) This scheme adopts distributed acoustic sensing (DAS) technology and dynamic displacement acquisition technology to realize real-time data acquisition and transmission. By rapidly acquiring vibration signals and displacement data, it provides timely and reliable basic data for the dynamic evaluation of slope surface deformation.

(3) The optical fiber material in this scheme is corrosion-resistant and anti-aging, giving it a long service life. It does not need to be maintained as frequently as traditional electrical sensors, which greatly reduces the maintenance cost of long-term monitoring and makes it suitable for slope monitoring projects that require long-term, stable operation.

(4) This scheme can accurately detect small strain and displacement changes on the slope surface, and it features high sensitivity. It can be used to detect early-stage deformation or damage of the slope surface and provide timely early warning, thus helping to avoid greater landslide safety hazards.

(5) The optical fiber monitoring system has strong anti-electromagnetic interference capability and is not affected by external environmental factors such as lightning, corrosion, and high temperature; even under harsh climatic and geological conditions, the monitoring system can still maintain stable and reliable operation;

(6) Through distributed optical fiber technology, this scheme can realize comprehensive monitoring of large-scale, long-distance slopes, overcome the limitations of traditional point sensors, and provide a holistic health assessment of slope stability.

The following is a further detailed description of the method scheme of the present disclosure through the drawings and implementation examples.

### BRIEF DESCRIPTION OF THE DRAWINGS

FIG. 1 is a flow chart of the slope stability monitoring and evaluation method based on DAS optical fiber-displacement coordination.

FIG. 2 is a schematic diagram of the physical model of the slope of the present disclosure;

FIG. 3 is a schematic diagram of the DAS signal warning interface of the embodiment of the present disclosure.

FIG. 4 is a waveform of the vibration signal of the embodiment of the present disclosure;

FIG. 5 is a schematic diagram of the displacement signal acquisition interface of the dynamic displacement meter.

### DETAILED DESCRIPTION

The following is a further explanation of the scheme of the present disclosure through drawings and implementation examples.

Unless otherwise defined, the methodological or scientific terms used in the present disclosure shall have the usual meaning understood by persons with general skills in the field to which the present disclosure belongs.

Similar words, such as ‘include’ or ‘comprise’ used in this present disclosure, mean that the elements before the word cover the elements enumerated after the word, and do not exclude the possibility of covering other elements as well. The orientation or positional relationship indicated by the terms ‘inner’, ‘outer’, ‘upper’, ‘lower’, etc. is based on the orientation or positional relationship shown in the attached figure, which is only for the convenience of describing the present disclosure and simplifying the description, rather than indicating or suggesting that the device or component referred to must have a specific orientation, be constructed and operated in a specific orientation, so it cannot be understood as a restriction on the present disclosure. When the absolute position of the described object changes, the relative positional relationship may also change accordingly. In the present disclosure, unless otherwise clearly defined and qualified, terms such as ‘attachment’ shall be understood in a broad sense, for example, may be a fixed connection, may be a detachable connection, or may be integrated; it can be directly connected or indirectly connected through an intermediate medium, which can be the internal connection of two components or the interaction between two components. For ordinary technicians in this field, the specific meaning of the above terms in this present disclosure can be understood according to the specific situation.

### Implementation Example

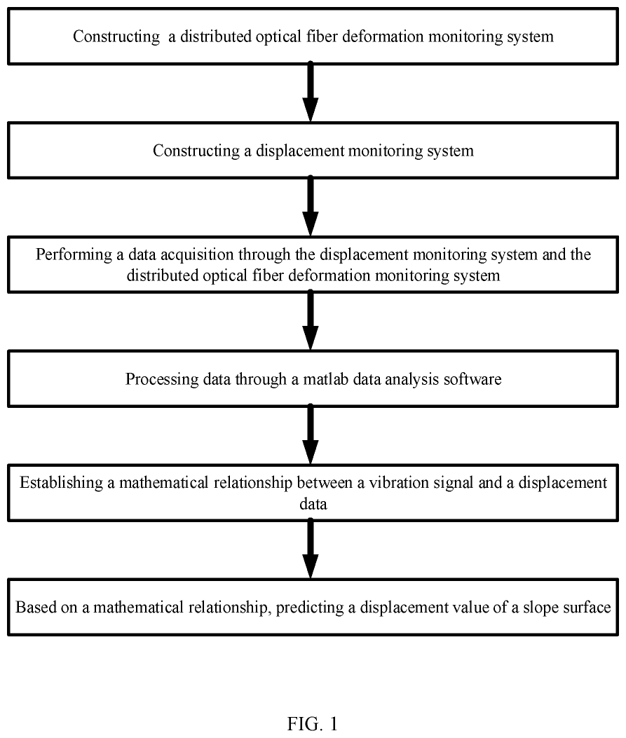

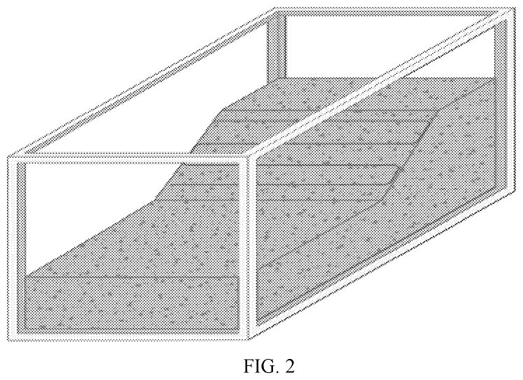

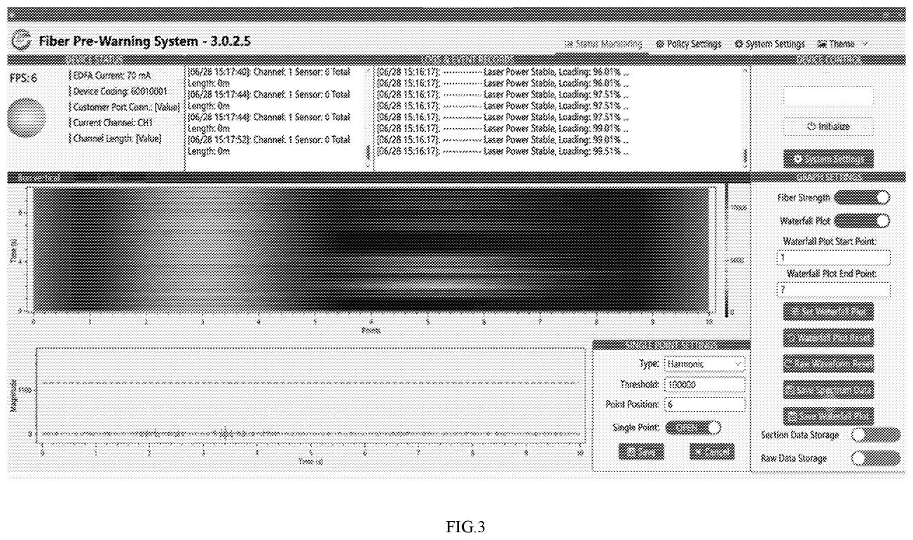

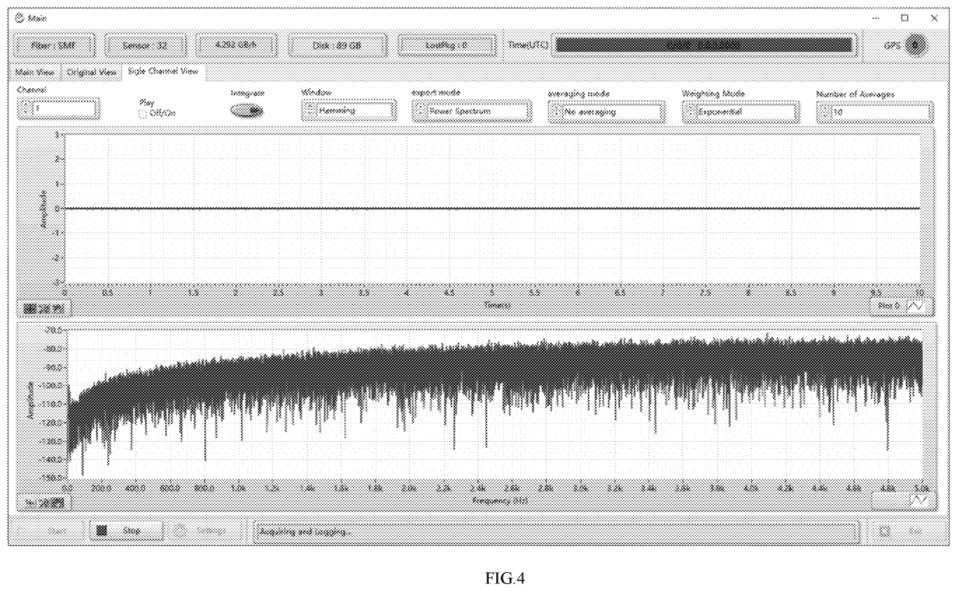

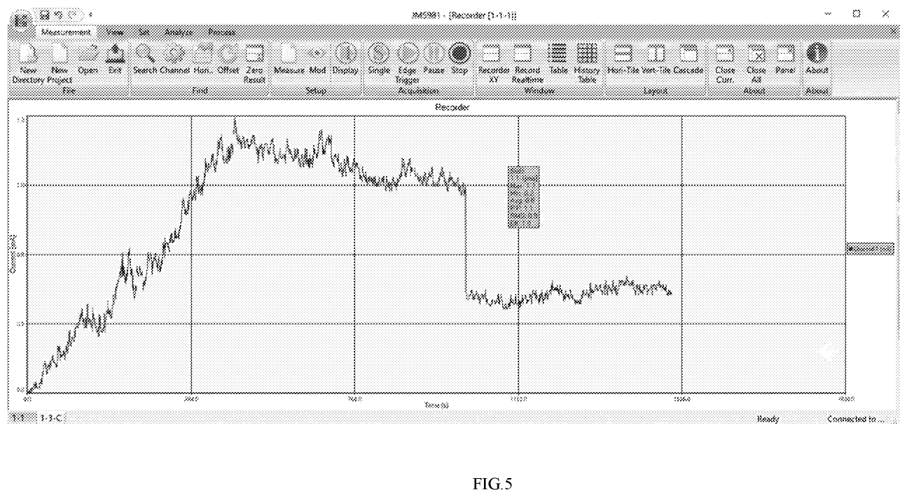

As shown in FIG. 1-FIG. 5, the present disclosure provides a slope stability monitoring and evaluation method based on DAS fiber-displacement coordination, including the following steps:
S1: A distributed optical fiber deformation monitoring system is constructed;
S1 includes the following steps:
S11: The physical model of the slope is constructed. The physical model of the slope includes the model box and the expansive soil set inside the model box. The box wall of the model box adopts tempered glass, and the edge of the model box adopts square steel.
S12: Layering along different elevation levels, the laying route of single-mode optical fiber is marked on the slope surface of expansive soil, and a transition curve at the turning point of the path is adopted to effectively capture the vibration signal under rainfall; the optical fiber groove is carved according to the laying route, the width and depth of the optical fiber groove need to be accurately controlled according to the diameter of the single-mode optical fiber to ensure that the single-mode optical fiber is tightly bonded and does not affect the stability of the optical signal.
S13: The single-mode fiber is laid in the fiber groove, and the fiber groove is backfilled and compacted after the laying is completed.
S2: The displacement monitoring system is constructed;
S2 specifically includes the following steps:
S21: A full-bridge cable-stayed displacement sensor is set on the slope surface of expansive soil, the full-bridge cable-stayed displacement sensor is set in the middle and lower part of the slope surface to ensure that it is located in the slope slip surface area to obtain accurate displacement of the slope surface data, the fixed end of the full-bridge cable-stayed displacement sensor is a stable anchorage, and the movable end is connected to the surface measuring point of expansive soil.
S22: Temperature and humidity sensors and dial gauges are set on the slope surface of expansive soil;
S23: The spray device is set on the top of the model box.
S3: The data acquisition is performed through a displacement monitoring system and a distributed optical fiber deformation monitoring system;
S3 specifically includes the following steps:
S31: The rainfall process is simulated by the spray device, the rainfall intensity is simulated by the spray intensity, and the temperature and humidity of the expansive soil are obtained by the temperature and humidity sensor during the simulated rainfall process.
S32: The slope slip is simulated during rainfall, the vibration signal is generated, and the vibration signal is transmitted to the single-mode optical fiber through the expansive soil, according to the distribution characteristics of the vibration signal, the distributed dynamic monitoring of the slope surface deformation under rainfall is realized, covering the entire slope physical model to achieve large-scale and high-precision displacement change assessment;
S33: The single-mode fiber is connected to the DAS interrogator, and the vibration signal is collected in real time through the DAS interrogator, and the acquisition frequency is adjusted according to the spray intensity and the characteristics of expansive soil to capture the complete vibration signal.
S34: The full bridge cable displacement sensor is connected with the dynamic displacement meter, and the displacement data of the slope is collected in real time by the dynamic displacement meter to record the displacement change of the slope.
S4: The data is processed through the matlab data analysis software;
S4 includes the following steps:
S41: The vibration signal is denoised by matlab data analysis software to remove environmental interference and measurement noise;
S42: Fourier transform is performed on the denoised vibration signal, and the vibration signal is converted from the time domain to the frequency domain to extract the frequency domain characteristics of the vibration signal.
S43: The displacement data is analyzed by matlab data analysis software, and the singular values and abnormal points are eliminated to ensure the accuracy of the data.
S5: The mathematical relationship between the vibration signal and the displacement data is established;
S5 specifically includes the following steps:
S51: The trend analysis of the frequency domain characteristics of the vibration signal is performed, and the characteristic variables related to the deformation of the slope surface are extracted. The characteristic variable extraction method is set as follows:

$${F}_{feature} ( x , t ) = \frac{{\int }_{{f}_{1}}^{{f}_{2}} S ( f , x , t ) \cdot W ( f ) df}{{\int }_{{f}_{min}}^{{f}_{max}} S ( f , x , t ) df}$$

where F_{feature}(x,t) denotes the extracted frequency domain characteristic variable, S(f,x,t)
denotes the frequency domain amplitude of the vibration signal at frequency f, position x and time t, [f₁, f₂] denotes the characteristic frequency interval related to the slope surface deformation, W(f) denotes the frequency weight function, and [fₘᵢₙ, fₘₐₓ] denotes the effective frequency range;
S52: According to the change trend of displacement data, the displacement variation characteristics of the slope under rainfall are determined.
S53: Based on the change trend of vibration signal and displacement data, the mathematical relationship between vibration signal and displacement data is established, the mathematical relationship between vibration signal and displacement data is set as follows:

$$D ( x , t ) = {\int }_{{f}_{min}}^{{f}_{max}} [ α ( f ) \cdot S ( f , x , t ) ] df + β \cdot \frac{\partial S}{\partial x} + γ ;$$

where D(x,t) denotes the displacement of the slope surface at frequency f, position x and time t, α(f) denotes the frequency response function, β denotes a spatial gradient coefficient, and γ denotes the system error or background noise compensation term.
S6: Based on the mathematical relationship, the displacement value of the slope surface is predicted.
Step S6 specifically includes the following steps:
S61: Based on the mathematical relationship between the vibration signal and the displacement data and the frequency domain characteristics of the vibration signal, the displacement of the slope surface is quantified;
S62: Based on quantitative processing results, predicting a displacement value of the slope surface, and obtaining a displacement prediction value \hat{D}(x,t) of the slope surface, the displacement prediction value \hat{D}(x,t) of the slope surface is set as:

\hat{D}(x,t)=K·ln(1+F_{feature}(x,t)+D₀;
where K denotes the model gain coefficient, D₀ denotes the initial displacement reference;
S63: The prediction results are shown through visualization tools or data reports.

Therefore, the present disclosure adopts the above-mentioned slope stability monitoring and evaluation method based on DAS optical fiber-displacement coordination, which has the characteristics of distributed, high efficiency, and non-destructive testing. Combined with distributed optical fiber monitoring technology and displacement monitoring technology, the real-time monitoring and dynamic evaluation of slope stability can be realized, which provides a scientific basis for slope disaster early warning management.

Finally, it should be noted that the above implementation examples are only used to explain the method scheme of the present disclosure rather than to restrict it. Although the present disclosure is described in detail with reference to the better implementation examples, the ordinary method personnel in this field should understand that they can still modify or replace the method scheme of the present disclosure, and these modifications or equivalent replacements cannot make the modified method scheme out of the spirit and scope of the method scheme of the present disclosure.

What is claimed is:

1. A slope stability monitoring and evaluation method based on DAS optical fiber-displacement synergy, it comprises the following steps:
S1: constructing a distributed optical fiber deformation monitoring system;
S2: constructing a displacement monitoring system;
S3: performing a data acquisition through the displacement monitoring system and the distributed optical fiber deformation monitoring system;
S4: processing data through a matlab data analysis software;
wherein S4 specifically includes the following steps:
S41: denoising the vibration signal by matlab data analysis software to remove environmental interference and measurement noise;
S42: performing a Fourier transform on denoised vibration signal to convert a vibration signal from a time domain to a frequency domain, and extracting frequency domain characteristics of the vibration signal;
S43: analyzing displacement data by matlab data analysis software, and eliminating singular values and abnormal points;
S5: establishing a mathematical relationship between the vibration signal and the displacement data;
wherein S5 specifically comprises the following steps:
S51: performing a trend analysis of the frequency domain characteristics of the vibration signal, and extracting characteristic variables related to a deformation of the slope surface; a characteristic variable extraction method is set as follows:
$${F}_{feature} ( x , t ) = \frac{{\int }_{{f}_{1}}^{{f}_{2}} S ( f , x , t ) \cdot W ( f ) df}{{\int }_{{f}_{min}}^{{f}_{max}} S ( f , x , t ) df}$$
where F_{feature}(x,t) denotes an extracted frequency domain characteristic variable, S(f,x,t) denotes a frequency domain amplitude of the vibration signal at frequency f, position x and time t, [f₁, f₂] denotes a characteristic frequency interval related to the slope surface deformation, W(f) denotes a frequency weight function, and [fₘᵢₙ, fₘₐₓ] denotes an effective frequency range;
S52: according to a change trend of displacement data, determining displacement variation characteristics of a slope under rainfall;
S53: based on change trends of the vibration signal and the displacement data, establishing a mathematical relationship between the vibration signal and the displacement data; the mathematical relationship between the vibration signal and the displacement data is set as follows:
$$D ( x , t ) = {\int }_{{f}_{min}}^{{f}_{max}} [ α ( f ) \cdot S ( f , x , t ) ] df + β \cdot \frac{\partial S}{\partial x} + γ ;$$
where D(x,t) denotes a displacement of the slope surface at frequency f, position x and time t, α(f) denotes a frequency response function, β denotes a spatial gradient coefficient, and γ denotes a system error or background noise compensation term;
S6: based on a mathematical relationship, predicting a displacement value of a slope surface;
wherein S6 specifically comprises the following steps:
S61: based on the mathematical relationship between the vibration signal and the displacement data and the frequency domain characteristics of the vibration signal, quantifying the displacement of the slope surface;
S62: based on quantitative processing results, predicting a displacement value of the slope surface, and obtaining a displacement prediction value \hat{D}(x,t) of the slope surface, the displacement prediction value \hat{D}(x,t) of the slope surface is set as:
\hat{D}(x,t)=K·ln(1+F_{feature}(x,t)+D₀;
where K denotes a model gain coefficient, D₀ denotes an initial displacement reference
S63: showing a prediction result through visualization tools or data reports.

2. The slope stability monitoring and evaluation method based on DAS optical fiber-displacement synergy according to claim 1, wherein S1 comprises the following steps:
S11: constructing a physical model of the slope, the physical model of the slope comprises a model box and expansive soil set inside a model box; the box wall of the model box adopts tempered glass, and an edge of the model box adopts square steel;
S12: layering along different elevation levels, marking a laying route of single-mode optical fiber on a slope surface of expansive soil, and engraving an optical fiber groove according to the laying route; and
S13: laying a single-mode fiber in the fiber groove, and backfilling and compacting the fiber groove after the laying is completed.

3. The slope stability monitoring and evaluation method based on DAS optical fiber-displacement synergy according to claim 2, wherein S2 comprises the following steps:
S21: setting a full-bridge cable-stayed displacement sensor on a slope surface of expansive soil, and setting the full-bridge cable-stayed displacement sensor on a middle and lower part of the slope surface;
S22: setting a temperature and humidity sensor and a dial gauge on the slope surface of expansive soil;
S23: setting a spray device on a top of the model box.

4. The slope stability monitoring and evaluation method based on DAS optical fiber-displacement synergy according to claim 3, wherein S3 specifically comprises the following steps:
S31: simulating a rainfall process by the spray device, simulating a rainfall intensity by a spray intensity, and obtaining a temperature and a humidity of the expansive soil by the temperature and humidity sensor during a simulated rainfall process;
S32: simulating a slope slip in the rainfall process, generating a vibration signal, and transmitting the vibration signal to the single-mode fiber through the expansive soil;
S33: connecting the single-mode fiber to the DAS interrogator, and connecting the vibration signal in real time through the DAS interrogator, and adjusting an acquisition frequency according to the spray intensity and characteristics of expansive soil; and
S34: connecting the full bridge cable displacement sensor with a dynamic displacement meter, and collecting displacement data of the slope in real time by the dynamic displacement meter to record a displacement change of the slope.
